(19) United States
(12) Patent Application Publication
(10) Pub. No.: US 2008/0109607 A1
(43) Pub. Date: May 8, 2008

(54) METHOD, SYSTEM AND ARTICLE FOR MANAGING MEMORY

(75) Inventors: Tara L. Astigarraga, Tucson, AZ (US); Michael E. Browne, Staatsburg, NY (US); Joseph Demczar, Salt Point, NY (US); Eric C. Wieder, New Paltz, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/555,814

(22) Filed: Nov. 2, 2006

(51) Int. Cl. G06F 12/08

(52) U.S. Cl. 711/135; 711/E12.054; 711/E12.022

(57) ABSTRACT

A memory management method is disclosed. In response to a process running in a first memory and the first memory becoming constrained by demands from another process, information in the first memory is paged out to a second memory. In response to a request to further run the process, the information from the second memory is paged into a read cache and then into the first memory, while a copy of the information is left the read cache. In response to the information in the first memory then being updated and the copy of the information in the read cache now becoming stale, the now stale copy of the information in the read cache is checked for and purged, and indication is provided that the read cache has been purged.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to memory management for computer systems, and particularly to memory management for cache memory.

2. Description of Background

Absent our invention, storage cache management is limited by the fact that the algorithms used to control cache management and data retention lack the intelligence in many cases to fully optimize the use of the storage controller cache. In most cases algorithms like the LRU (Least Recently Used) Algorithm are used. These algorithms are very useful. However, additional areas for storage cache management improvement still exist.

Absent our invention, after a memory page is paged out to secondary storage and then paged back into real memory due to a virtual memory demand request, and then the page in real memory is modified, the previous stale version may also still be residing in the storage controller cache, which may cause other valid data to be migrated out from the cache when additional storage controller space is needed based on current cache optimization algorithms, typically a LRU algorithm. Methods of cache optimization other than our invention have been proposed and implemented, however, they do not include sending the storage controller a command to delete stale pages from read cache when pages have been modified and are no longer valid.

### SUMMARY OF THE INVENTION

The shortcomings of the prior art are overcome and additional advantages are provided through the provision of sending the storage controller a command to delete stale pages from read cache when pages have been paged out of a primary memory, then paged back into primary memory, and then modified, resulting in the page in read cache being no longer valid, or stale.

The shortcomings of the prior art are overcome and additional advantages are provided through the provisions of paging out information relating to a process running in a first memory to a second memory in response to the first memory becoming constrained by demands from another process, paging in the information, in response to a page in request for further running of the process, from the second memory to the read cache and then to the first memory, leaving a copy in read cache, updating the information in the first memory, resulting in the copy of the information in the read cache becoming stale, checking for and purging the copy of the information in the read cache, and providing indication that the read cache has been purged.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which purges stale pages from read cache when pages have been modified and are no longer valid, thereby freeing up valuable memory resources previously underutilized.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system for implementing a memory management method in accordance with embodiments of the invention.

FIG. 2 illustrates one example of a memory management method in flow diagram form in accordance with embodiments of the invention.

FIG. 3 illustrates another example of a memory management method in flow diagram form in accordance with embodiments of the invention.

The detailed description explains the preferred embodiments of the invention, together with advantages and features, by way of example with reference to the drawings.

### DETAILED DESCRIPTION OF THE INVENTION

In an embodiment, additional cache management is employed using a delete command to purge stale pages from read cache, an additional data bit in the page data structure is employed to denote the existence of the page in the storage controller read cache, and a method is employed for having the storage controller inform the server operating system of pages that have been removed from the read cache.

In an embodiment, commands are sent to a storage controller to purge the stale versions of pages being stored in the storage controller read cache, or optionally commands are sent to a command queuing mechanism within the operating system as needed to purge the stale versions of the pages being stored in the storage controller read cache.

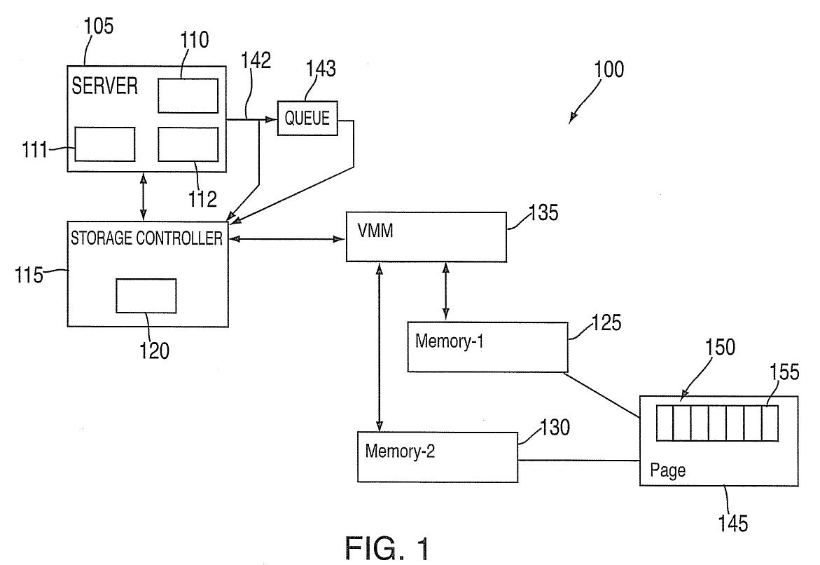

Turning now to the drawings in greater detail, it will be seen that FIG. 1 depicts, in block diagram form, a system 100 for carrying out a method for managing a storage controller read cache. In an exemplary embodiment, system 100 includes a server 105 having a processing circuit 110 for executing program code of an operating system 111, which executes computer readable code for executing a system process or a plurality of system processes depending on system demands. A memory 112 is provided for executing program instructions in accordance with embodiments of the invention, the memory 112 being in an embodiment an article of manufacture that includes a computer readable medium having computer readable program code embodied therein or theron, the computer readable program code for implementing methods disclosed herein. As used herein, the term Process-A will be used to define a given system process under consideration. In an embodiment, a storage controller 115 is in signal communication with the server 105, and includes a read/write cache 120. A first memory 125, such as virtual memory for example, is configured to run Process-A, and a second memory 130, such as a disk drive for example, is configured to receive paged out information from the first memory 125 in response to the first memory 125 becoming constrained by demands from another system process. A virtual memory manager (VMM) 135 is employed to manage the paging in and out of information to and from first memory 125. The server 105 is responsive to a command from the operating system 110 to purge the read cache 120, which will be described in more detail below.

For exemplary purposes, the information that is paged from and to the first memory 125 is also herein referred to as a 4 k page 145, which has a page data structure 150 composed of meta-data structure bits for identifying attributes of information within the 4 k page. In accordance with an embodiment of the invention, the meta-data structure bits include a defined data bit 155 that is configured to denote the existence or absence of the page of information within the read cache 120. The defined data bit 155 may also herein be referred to as an “exists in storage controller cache” bit. Further utilization of this defined data bit 155 will be discussed in more detail below.

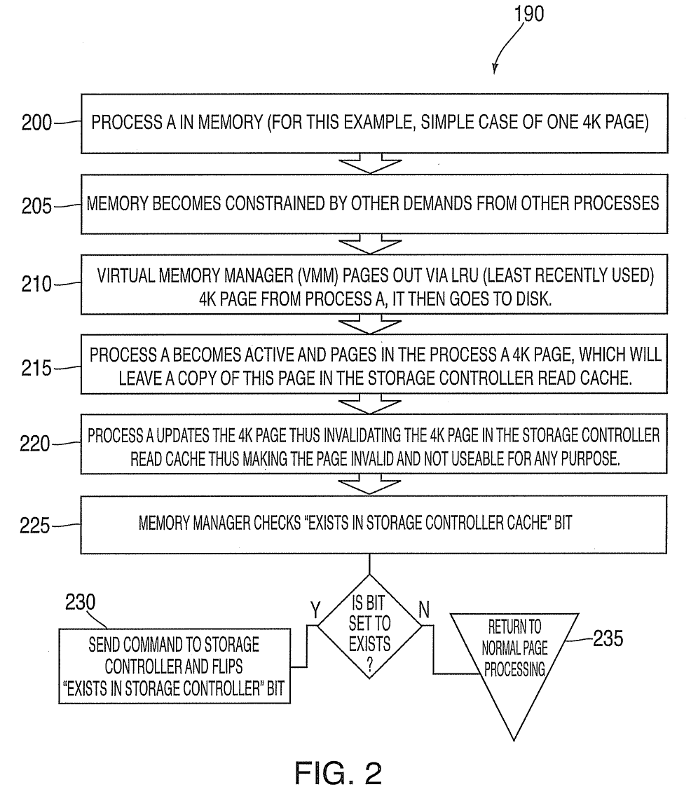

Referring now to FIG. 2, a method 190 is depicted in flowchart form for managing the read cache 120 of the storage controller 115. At block 200, Process-A is in first memory 125, which for exemplary purposes only will be referred to as a 4 k page. At block 205, first memory 125 becomes constrained by other demands from other processes. At block 210, the VMM 135 pages out, via a least recently used (LRU) algorithm, the 4 k page from Process-A, which then goes to second memory 130. At block 215, the operating system re-activates Process-A, causing VMM 135 to page in the Process-A 4 k page to read cache 120 and then to first memory 125, leaving a copy of the 4 k page in the storage controller read cache 120. At block 220, Process-A updates the 4 k page, thus invalidating the 4 k page in the server memory, which makes the 4 k page in the storage controller read cache 120 invalid (stale) and not useable for any purpose.

At block 225, in response to the invalidation of the 4 k page in the server 105 operating system, the server 105 checks the defined data bit 155 in the 4 k page 145 to ascertain whether the defined data bit 155 is set to denote that the 4 k page 145 exists in the storage controller read cache 120. As discussed above, this defined data bit 155 is referred to as the “exists in storage controller cache” bit. At block 230, if the 4 k page 145 exists in the storage controller read cache 120, the storage controller 115 acknowledges this existence, and the VMM 135 marks the defined data bit 155 to denote the existence of the 4 k page 145 in storage controller read cache 120. At block 235, if the 4 k page 145 does not exist in the storage controller read cache 120, the storage controller 115 acknowledges the absence, but the VMM 135 also marks the defined data bit 155 to signify the existence of the 4 k page 145 in storage controller read cache 120, meaning that the defined data bit 155 is set at block 235 regardless of the check command completing successfully or not. By so marking the defined data bit 155, the VMM 135 has stopped all future requests to delete the 4 k page from the storage controller read cache 120 until a new updated page has been paged out and then paged back in. If the check command does not complete successfully, the 4 k page 145 in the storage controller read cache 120 was most likely removed via the LRU algorithm from inside the storage controller read cache 120. If some other error condition occurs and the 4 k page is marked deleted, repeatedly retrying the check command will most likely produce a negative performance impact.

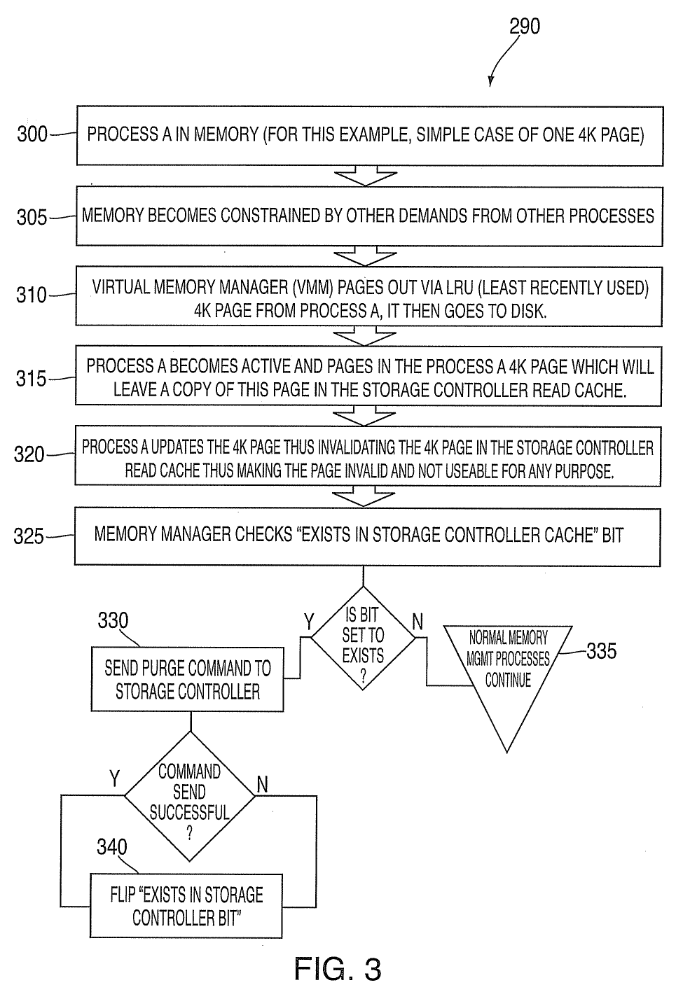

Referring now to FIG. 3, an alternative method 290 is depicted in flowchart form for managing the read cache 120 of the storage controller 115. In FIG. 3, blocks 300, 305, 310, 315, 320 and 325, are synonomous with blocks 200, 205, 210, 215, 220 and 225, of FIG. 2, respectively, and therefore the description for those blocks are not repeated here. As such, the discussion of FIG. 3 will commence at block 330.

At block 330, if the 4 k page 145 exists, or is indicated to exist, in the storage controller read cache 120, and after a new 4 k page has been paged out, paged back in, and updated, the server 105 sends a purge command to the storage controller 115 to remove the now stale 4 k page from the read cache 120, the now stale 4 k page having become stale in response to the aforementioned paging out, paging in, and updating. At block 335, if the 4 k page 145 does not exist in the storage controller, the normal memory management processes continue.

At block 340, in response to the purge command having been sent, but regardless of whether the purge command was sent successfully or not, that is, whether or not the purge command is confirmed as having been sent, the VMM 135 flips the defined data bit 155 to now indicate that the stale 4 k page has been purged from the read cache 120. By contemporaneously sending the purge command and flipping the defined data bit 155 to indicate a purged read cache, it is not necessary to repeatedly check the state of the defined data bit where many processes are executed in rapid fashion, thereby immediately making available memory resources that would ordinarily go underutilized.

In an alternative embodiment, if the 4 k page 145 for Process-A in primary memory 125 now needs to be paged out again due to other memory demands, the VMM 135 (or other memory management system employed for the purposes disclosed herein) would migrate the page out to the secondary memory 130, or disk. When the page for Process-A again needs to be paged back in to the primary memory 125, the VMM 135 would request the page. In response, the needed page would then be moved from secondary memory 130 to storage controller read cache 120, and subsequent thereto, the page would then be moved to primary memory 125. In response to the paging in, the VMM 135, or other server memory management subsystem employed for the purposes disclosed herein, would then mark the defined data bit 155 of the page data structure to denote that the 4 k page exists in the storage controller read cache 120. In response to a future page invalidation occurring in a memory of the system 100, the bit updating process and commands for the storage controller would be started again.

In view of the foregoing discussion, it will be appreciated that the server 105 is configured to send a purge command 142 to purge the read cache 120 in response to: paging out the information from the first memory 125 to the second memory 130; subsequent to the copying, further executing the process by paging in the information from the second memory 130 to the read cache 120 and then into the first memory 125, but leaving a copy of the information in the read cache 120; subsequent to the paging in, updating the information in the first memory 125, resulting in the copy of the information in the read cache 120 becoming stale; and subsequent to the updating, confirming the existence of the now stale copy of the information in the read cache 120. The defined data bit 155 is settable by the VMM 135 via a purge command from the server 105 to the storage controller 115 to indicate that the read cache 120 has been purged, and in response to the purge command being sent to purge the read cache 120, the storage controller 115 is configured to inform the operating system that the read cache 120 has been purged.

In further view of the foregoing discussion, it will be appreciated that system 100, operating in accordance with exemplary methods 190 and 290, is configured to facilitate running a Process-A in first memory 125; facilitate paging out information (4 k page 145, for example) relating to the Process-A from first memory 125 to second memory 130 in response to first memory 125 becoming constrained by demands from another process; facilitate further running of the Process-A by paging in the information from second memory 130 to read cache 120 and then into first memory 125, but leaving a copy of the information in read cache 120; facilitate indication of the information existing in read cache 120 including setting dedicated bit 155 in memory page data structure 150 for the information to indicate a non-purged read cache condition, the dedicated bit 155 denoting the existence or absence of the information in the read cache; facilitate updating the information in first memory 125, resulting in the copy of the information in read cache 120 becoming stale; subsequent to the updating, facilitate checking for existence of the copy of the information in read cache 120; and, in response to the checking indicating the existence of the copy of the information in read cache 120, facilitate purging of the copy of the information in read cache 120, and facilitate indication of read cache 120 being purged.

In an embodiment, the facilitating purging of the copy of the information in read cache 120 occurs contemporaneously with the facilitating indication of read cache 120 being purged. In an embodiment, the facilitating purging of the copy of the information in read cache 120 includes sending a purge command 142 from server 105 to storage controller 115 for controlling read cache 120. In an embodiment, the facilitating purging of the copy of the information in read cache 120 includes sending a purge command 142 to a command queue 143, the command queue being accessible by an operating system on server 105 for purging stale versions of the information in read cache 120 on demand. In an embodiment, the facilitating indication of read cache 120 being purged includes setting defined data bit 155 (dedicated bit) in a memory page data structure 150 for the information to indicate a purged read cache condition, the dedicated bit 155 denoting the existence or absence of the information in the read cache.

In addition to the foregoing, embodiments of the invention also encompass a method that adds a delete command and new bit in the page data structure, and logic to better manage the storage controller read cache. An advantage to using this method would be additional cache optimization by removing outdated pages leaving additional cache room for current and relevant pages to be stored. An additional benefit of this cache optimization is that fewer pages will be in cache, thereby reducing the process time for the various garbage collection algorithms within the storage controller microcode. Further, by pro-actively purging these outdated pages, there is a reduced chance for bugs to occur by reading in stale data from the storage controller cache.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A memory management method, comprising:
facilitating running a process in a first memory;
facilitating paging out information relating to the process from the first memory to a second memory in response to the first memory becoming constrained by demands from another process;
subsequent to the paging out, facilitating further running of the process by paging in the information from the second memory to the read cache and then into the first memory but leaving a copy of the information in the read cache;
facilitating updating the information in the first memory, resulting in the copy of the information in the read cache becoming stale;
subsequent to the updating, facilitating checking for existence of the copy of the information in the read cache; and
in response to the checking indicating the existence of the copy of the information in the read cache, facilitating purging of the copy of the information in the read cache, and facilitating indication of the read cache being purged.

2. The method of claim 1, wherein:
the facilitating purging of the copy of the information in the read cache occurs contemporaneously with the facilitating indication of the read cache being purged.

3. The method of claim 1, wherein:
the facilitating purging of the copy of the information in the read cache comprises sending a purge command from a server to a storage controller for controlling the read cache.

4. The method of claim 1, wherein:
the facilitating indication of the read cache being purged comprises setting a dedicated bit in a memory page data structure for the information to indicate a purged read cache condition, the dedicated bit denoting the existence or absence of the information in the read cache.

5. The method of claim 1, further comprising:
in response to the paging in the information in a read cache, facilitating indication of the paged information existing in the read cache.

6. The method of claim 5, wherein:
the facilitating indication of the paged information existing in the read cache comprises setting a dedicated bit in a memory page data structure for the information to indicate a non-purged read cache condition, the dedicated bit denoting the existence or absence of the information in the read cache.

7. The method of claim 4, further comprising:
in response to the paging in the information in a read cache, facilitating indication of the paged information existing in the read cache.

8. The method of claim 7, wherein:
the facilitating indication of the paged information existing in the read cache comprises setting a dedicated bit in a memory page data structure for the information to indicate a non-purged read cache condition, the dedicated bit denoting the existence or absence of the information in the read cache.

9. The method of claim 1, wherein:
the facilitating purging of the copy of the information in the read cache comprises sending a purge command to a command queue, the command queue being accessible by an operating system for purging stale versions of the information in the read cache on demand.

10. A system for managing memory, comprising:
a server having a processing circuit and an operating system executable by the processing circuit for executing a system process;
a storage controller having a read cache;
a first memory configured to run the process;
a second memory configured to receive paged out information from the first memory in response to the first memory becoming constrained by demands from another process;
the server being responsive to a command from the operating system to purge the read cache; and
a virtual memory manager for managing paging of information to and from the first memory and the second memory;
wherein the server is configured to send a purge command to purge the read cache in response to: paging out the information from the first memory to the second memory; subsequent to the paging out, further executing the process by paging in the information from the second memory to the read cache and then into the first memory but leaving a copy of the information in the read cache; subsequent to the paging in, updating the information in the first memory, resulting in the copy of the information in the read cache becoming stale; and subsequent to the updating, confirming the existence of the now stale copy of the information in the read cache.

11. The system of claim 10, wherein:
in response to the read cache being purged, the storage controller is further configured to provide indication that the read cache has been purged.

12. The system of claim 11, further comprising:
an embedded page data structure comprising meta-data structure bits for identifying attributes of information within a page of data, the meta-data structure bits comprising a defined data bit configured to denote the existence or absence of the page of information within the read cache.

13. The system of claim 12, wherein:
the defined data bit is settable by the virtual memory manager via a purge command to indicate that the read cache has been purged.

14. The system of claim 10, wherein:
in response to the purge command being sent to purge the read cache, the storage controller is configured to inform the operating system that the read cache has been purged.

15. An article of manufacture for use with a computer system, the article of manufacture comprising a computer readable medium having computer readable program code embodied in or on the medium, the computer readable program code for implementing the method of claim 1.
